(19) United States
(12) Patent Application Publication
(10) Pub. No.: US 2008/0027985 A1
(43) Pub. Date: Jan. 31, 2008

(54) GENERATING SPATIAL MULTIMEDIA INDICES FOR MULTIMEDIA CORPUSES

(75) Inventors: Tomasz S.M. Kasperkiewicz, Redmond, WA (US); Richard S. Szeliski, Bellevue, WA (US); Blaise H. Aguera y Arcas, Seattle, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 11/461,311

(22) Filed: Jul. 31, 2006

(51) Int. Cl. G06F 17/00

(52) U.S. Cl. 707/104.1

(57) ABSTRACT

A method, system and media for generating and querying spatial multimedia indices are provided. A multimedia corpus representing varying view points and distributed across a large network, such as the Internet, is crawled to extract properties from the multimedia. The extracted properties and relationships among multimedia are stored and indexed in clusters associated with a space-scale hierarchy. Accordingly, a spatial multimedia service may utilize the space-scale hierarchy to update the spatial multimedia indices and to respond to user queries.

### BACKGROUND

Conventionally, search indices store documents, webpages, photographs and related keywords. The search indices normally include inverted indices that relate the documents, webpages or photographs with one or more keywords proximate to the photographs or one or more keywords included in the documents or webpages. Additionally, the one or more keywords stored in the search indices may include user-defined labels associated with the photographs.

A user search including one or more phrases is performed by presenting the one or more phrases to a search engine. The search engine extracts the one or more phrase from the user search and initiates a pattern match between the one or more phrases and the keywords stored in the search indices. Typically, the search indices respond with a result set that includes documents, webpages and/or photographs that are associated with keywords that match the user search.

Conventional peer-to-peer and web-based technologies allow users to search, browse and share millions of photographs via e-mail, personal digital assistants, cell phones, web pages, community sharing services, etc. The peer-to-peer and web-based technologies create a large volume of web-accessible photographs rich with implicit semantic information that may be gleaned from the surrounding textual context, links, and other photographs on the same page. However, the conventional search indices and search engines fail to properly extract and consider pertinent two-dimensional and three-dimensional metadata that may be gleaned from the photographs or other multimedia content when responding to user queries. Furthermore, the search indices do not provide a suitable web of multimedia content that is hyperlinked and annotated to support two-dimensional to three-dimensional exploration of multimedia content representing areas of the world or universe.

### SUMMARY

The present invention relates to systems and methods for generating a spatial multimedia index that stores relationships between multimedia content. The spatial multimedia index is generated by crawling multimedia corpuses and extracting properties from multimedia having different viewpoints. The multimedia is associated with the extracted properties and clustered in a space-scale hierarchy. Relationships between and among the multimedia at each level of the space-scale hierarchy are stored in the spatial multimedia index. Additionally, the spatial multimedia index may interface with a query engine when processing a user query that returns multimedia that is related thereto.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a network diagram that illustrates an exemplary operating environment, according to an embodiment of the present invention;

FIG. 2A is a block diagram that illustrates a multimedia engine, according to an embodiment of the present invention;

FIG. 2B is a block diagram that illustrates a query engine, according to an embodiment of the present invention;

FIG. 3 is a schematic diagram that illustrates an island associated with multimedia, according to an embodiment of the present invention;

FIG. 4 a schematic diagram that illustrates a space-scale hierarchy, according to an embodiment of the present invention;

FIG. 5 is a block diagram that illustrates a mobile device generating a query, according to an embodiment of the present invention;

FIG. 6 is a flow diagram that illustrates a method for generating multimedia indices, according to an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Further, the present invention is described in detail below with reference to the attached drawing figures, which are incorporated in their entirety by reference herein.

“Multimedia,” as the term is utilized herein, refers to audio, video, images, photographs, and/or other documents that may be rendered by a computing device. Embodiments of the present invention provide spatial multimedia indices that store relationships among multimedia. A multimedia crawler crawls the Internet or suitable network having multimedia corpuses and extracts properties from the multimedia corpuses. The extracted properties are keypoints associated with multimedia. A keypoint is a feature that is likely to be invariant across a collection of images representing, at least in part, a common object. For instance, keypoints may include non-point based localized features, such as corners, arcs, patches of texture, or complex shapes for which suitable descriptors can be constructed. In some embodiments, the extracted properties are utilized to cluster the multimedia in a space-scale hierarchy. Also, the multimedia may be associated with semantic information that is provided by a user, extracted from the multimedia, or automatically provided by a spatial multimedia service. Accordingly, the spatial multimedia indices correlate and link together multimedia included in multimedia corpuses that are stored locally on an image capture device or remotely on a server executing the spatial multimedia service. When the multimedia is stored at a remote central location, multimedia format and digital rights management considerations may be resolved by the server. The server may provide access control based on user credentials and optimize the multimedia format and resolution to allow efficient transfer of the multimedia.

In an embodiment of the present invention, the multimedia may be indexed locally or remotely. A multimedia capture device may extract properties from multimedia captured and stored by the multimedia capture device, when indexing is performed locally. Alternatively, when indexing is performed remotely, the spatial multimedia service may communicate with a mobile multimedia capture device that sends multimedia or extracted properties to the spatial multimedia service, which replies with indexing information that may be included as metadata, such as time and date associated with the multimedia.

As utilized herein, “component” refers to any combination of hardware, software or firmware.

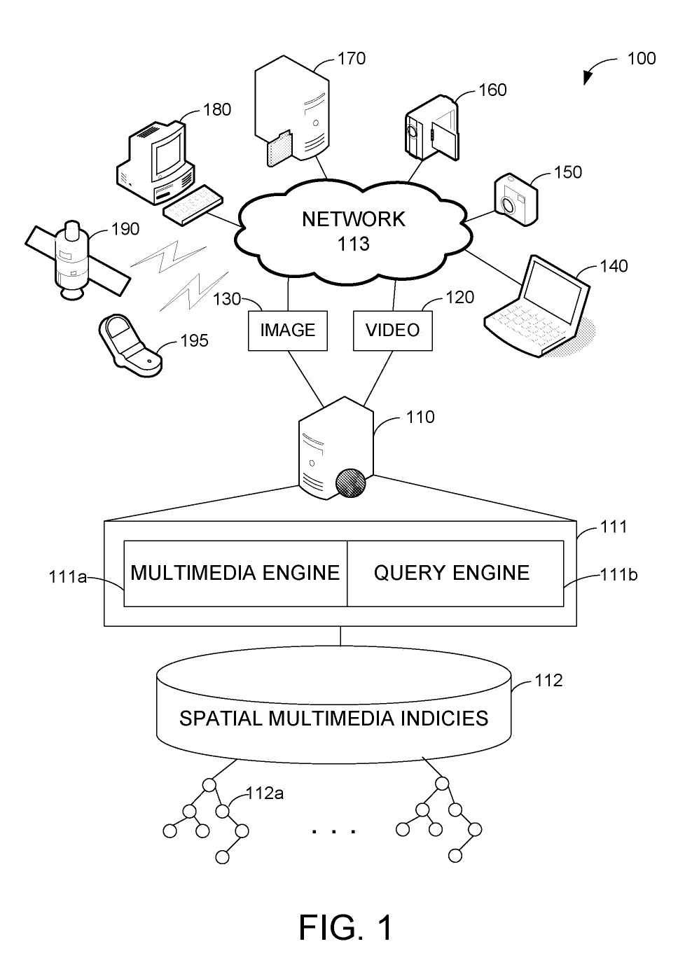

FIG. 1 is a network diagram that illustrates an exemplary operating environment 100, according to an embodiment of the present invention. The operating environment 100 shown in FIG. 1 is merely exemplary and is not intended to suggest any limitation as to scope or functionality. Embodiments of the invention are operable with numerous other configurations. With reference to FIG. 1, the operating environment 100 includes a spatial multimedia server 110, multimedia 120 and 130, a laptop 140, multimedia capture devices 150 and 160, a file server 170, a personal computer 180, a satellite 190, and a mobile device 195 in communication with one another through a network 113.

The spatial multimedia server 110 is configured to provide a spatial multimedia service 111 configured to respond to user queries and spatial multimedia indices 112 configured to store relationships between multimedia included in one or more multimedia corpuses. User queries may include multimedia queries or queries that specify one or more properties associated with the multimedia. The multimedia queries may specify one or more images in the query. Additionally, the spatial multimedia service 111 may be configured to generate indices that store relationships between multimedia 120 or 130 of one or more multimedia corpuses. The multimedia corpuses may be distributed across the network and stored at locations associated with client or server devices, e.g., 110, 140, 150, 160, 170, 180, 190 and 195.

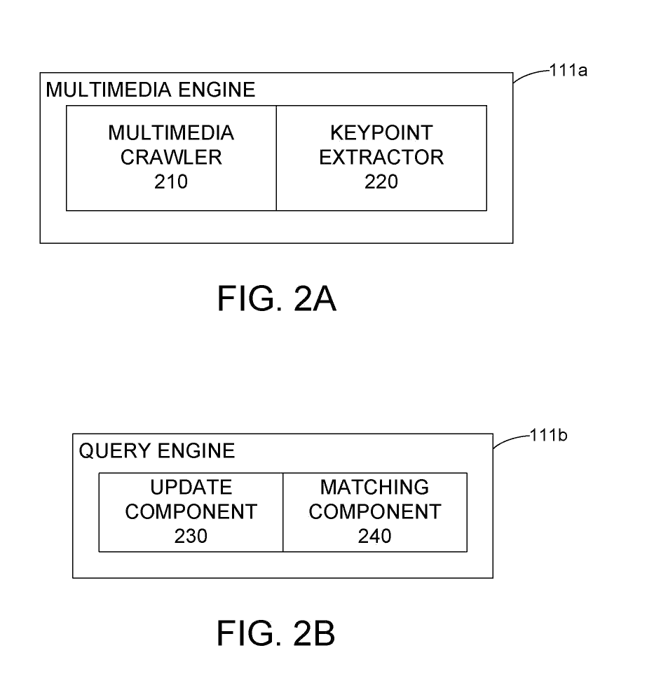

The spatial multimedia service 111 includes a multimedia engine 111a and a query engine 111b. The multimedia engine 111a is configured to generate the spatial multimedia indices. The query engine 111b is configured to interface with the spatial multimedia indices in response to user queries. The multimedia engine 111a and query engine 111b are further described below with reference to FIGS. 2A and 2B, respectively.

The spatial multimedia indices 112 store relationships between multimedia included in one or more multimedia corpuses. The relationships may include properties or semantic information extracted from the multimedia included in the one or more multimedia corpuses. For instance, the relationships may include geographic information and environment information. In some embodiments, the geographic information may include coordinates such as longitude and latitude, and the environment information may include, e.g., time of year, camera orientation, and the like. The relationships are extracted from the multimedia 120 and 130 and utilized to generate the spatial multimedia indices. In an embodiment, properties are extracted from the multimedia 120 and 130 via a multimedia property detector similar to scale invariant feature transform (SIFT). In some embodiments, the spatial multimedia indices provide a space-scale hierarchy 112a that is configured to store the properties corresponding to the multimedia. The space-scale hierarchy 112a may store references to the multimedia or actual multimedia content.

The network 113 is a communication network that allows client devices 140, 150, 160, 180 and 195 to communicate with each other or with server devices 110, 170 or 190. The client devices 140, 150, 160, 180 and 195 may send or receive multimedia 120 or 130 to or from the server devices 110, 170 or 190. The communication network 113 may be a local area network, a wide area network, satellite network, wireless network or the Internet.

Multimedia 120 and 130 are videos 120 and images 130 captured by multimedia capture devices 150 or 160. In other embodiments, The multimedia 120 and 130 is generated and provided by a satellite 190, mobile phone 195, or any other suitable multimedia capture device. Moreover, in other embodiments of the present invention, the multimedia may include audio, webpages, and the like.

In some embodiments, the laptop 140 may be configured to operate as a client device. The laptop may locally store multimedia 120 or 130 from different locations or events. For instance, the laptop may include multimedia 120 or 130 from a family trip to Sao Paulo, a wedding in Florence and an evening in Bordeaux. A user of the laptop 140 may transfer the multimedia 120 or 130 to the spatial multimedia service 111 to index the multimedia 120 or 130. In response, the spatial multimedia service may provide index information that is stored locally and associated with metadata for the multimedia 120 or 130. Alternatively, the laptop 140 may extract properties from the multimedia 120 or 130 and transmit the properties associated with the multimedia 120 or 130 to the spatial multimedia service 111. The spatial multimedia service 111 may store the properties at the spatial multimedia server 110 in a central location.

Additionally, the multimedia capture devices 150 and 160 may be configured to operate as a client device that captures the multimedia 120 or 130. One multimedia capture device 150 is illustrated as a camera for generating multimedia 120 or 130. The other multimedia capture device 160 is illustrated as a video camera for generating multimedia 120 or 130. It will be understood and appreciated by those of ordinary skill in the art that while only two image capture devices 150, 160 are illustrated in FIG. 1, such is by way of example only and that any number of image capture devices may be utilized within the scope of embodiments hereof. In some embodiments, multimedia capture devices 150 and 160 may be configured to extract properties and send the properties to the spatial multimedia service 111. In other embodiments, the multimedia capture devices 150 and 160 transfer the captured multimedia 120 or 130 to the spatial multimedia service 111 for indexing.

The file server 170 may be configured to operate as a server device and may store one or more multimedia corpuses that contain a variety of multimedia, e.g., video and/or images. The spatial multimedia service 111 may crawl the file server 170 to extract and index properties associated the multimedia corpuses.

The personal computer 180 may be configured to operate as a client device and may operate similar to laptop 140. The personal computer 180 may store multimedia 120 or 130 representative of a variety of places or objects, for instance, the Grand Canyon, Niagara Falls, Notre Dame in Paris, and the Statue of Liberty. In certain embodiments, the spatial multimedia service 111 may crawl the network 113 to extract properties from the multimedia 120 or 130 stored on one or more personal computers 180.

The satellite 190 may be configured to operate as a server device. Additionally, the satellite 190 may generate and store terrestrial multimedia 120 or 130. In some embodiments, the terrestrial multimedia 120 or 130 includes aerial images for a specified geographic location such as Seattle or Texas. The spatial image service 111 may receive and index the terrestrial multimedia 120 or 130 or properties associated therewith.

The mobile device 195 may be configured to operate as a client device. The mobile device may be enabled with global positioning system (GPS). In some embodiments, the mobile device 195 may capture and extract properties from multimedia 120 or 130. In some embodiments, the mobile device may issue queries that include multimedia or properties extracted from the multimedia to the spatial multimedia service 111. The mobile device 195 may receive index information from the spatial multimedia service 111 and associate the index information with the captured multimedia stored on the mobile device 195. Alternatively, the mobile device may receive a result set having multimedia with similar properties. For instance, when the multimedia service 111 receives a multimedia query having multimedia of the Eiffel tower, the multimedia service 111 may return a result set having multimedia with the Eiffel tower at different times of day, from different camera locations, and at different resolutions, etc.

Accordingly, the communication network 113 enables client devices 140, 150, 160, 180, and 195 to communicate multimedia 120 or 130 to the spatial multimedia service 111 and to receive index information having properties extracted from the multimedia. In some embodiments, the spatial multimedia service 111 may provide multimedia related to the multimedia stored locally at the client devices. One of ordinary skill in the art will understand and appreciate that the operating environment 100 illustrated in FIG. 1 is exemplary and has been simplified to facilitate exposition. Various other configurations are within the scope of embodiments of the present invention.

In some embodiments of the present invention, a multimedia engine generates spatial multimedia indices that store relationships between multimedia distributed across a network. The multimedia may be generated by multimedia capture devices and processed to generate index information that facilitates efficient access to the multimedia. Moreover, index information generated from the multimedia may be utilized to index other related new multimedia content that is subsequently added to the spatial multimedia indices. The spatial multimedia indices are generated by utilizing a multimedia crawler and keypoint extractor. The multimedia crawler gathers multimedia distributed across a network and the keypoint extractor extracts and stores properties associated with the gathered multimedia. In some embodiments, the multimedia engine receives and indexes multimedia that is transmitted from a client device.

FIG. 2A is a block diagram that illustrates the multimedia engine 111a, according to an embodiment of the present invention. The multimedia engine 111a includes a multimedia crawler 210 and a keypoint extractor 220. The multimedia engine is configured to generate and update the spatial multimedia indices 112. In some embodiments of the present invention, the multimedia engine 111a processes multimedia having two-dimensional properties or descriptors. In turn, the multimedia engine 111a estimates three-dimensional properties or surfaces derived from the multimedia, which may be received from a client device or gathered from a network having multimedia corpuses. The spatial multimedia indices 112 store the extracted relationships between properties for an estimated three-dimensional environment and the actual two-dimensional properties that provide the base from which the three-dimensional properties are derived. In an embodiment, the spatial multimedia indices 112 associate the extracted two-dimensional properties with the multimedia processed by the multimedia engine 111a. Additionally, the spatial multimedia indices 112 may store the estimated camera positions, orientations and focal lengths for each multimedia. Furthermore, descriptions of the planar and non-planar projection surfaces that are utilized to render and transition between the multimedia are stored in the spatial multimedia indices 112. In some embodiments, the planar and non-planar surfaces are three-dimensional surfaces that are estimated based on one or more multimedia corpuses corresponding to a specified location. The estimated surfaces may be described utilizing X, Y, and Z coordinates or any suitable three-dimensional system. In an embodiment of the invention, the spatial multimedia indices 112 may include a multimedia properties index, a properties concordance index, an island index, a properties spatial index, a multimedia viewpoint index, a multimedia projection index and a spatial tag index.

The multimedia crawler 210 may be executed on the spatial multimedia server 110 to crawl and gather multimedia stored locally or remotely. The multimedia stored locally at the server location may be high quality multimedia and/or multimedia received from a client device. The multimedia crawler 210 crawls multimedia stored remotely on a client or server device coupled to the network 113. The gathered multimedia generate one or more multimedia corpuses that are processed by the keypoint extractor 220. In some embodiments, the multimedia corpus may include one multimedia file, such as an image 130.

The keypoint extractor 220 extracts two-dimensional properties from the multimedia. The two-dimensional properties include descriptors of features that are invariant to camera position, scale, lighting and viewpoint. The keypoint extractor 220 creates a vector that assigns a descriptor to each two-dimensional property included in the multimedia. For example, multimedia containing a sign designating “Price St.” may utilize optical character recognition or any other suitable recognition technique to determine whether other multimedia contain the same sign. When other multimedia includes the sign and OCR recognizes “Prince St.” in each multimedia, “Prince St.” or suitable coordinate information is stored as a descriptor or two-dimensional property for the multimedia. In certain embodiments, the descriptor may be a vector that describes the surrounding region of the extracted two-dimensional property. In turn, the multimedia and extracted two-dimensional properties are further processed by the keypoint extractor 220 to estimate three-dimensional coordinates, focal length, orientation, and complex three-dimensional planar and non-planar projections that may be utilized for rendering the multimedia in a two or three-dimensional space. The extracted two-dimensional properties and estimated three-dimensional information are related to the multimedia and stored in the spatial multimedia indices 112.

In other embodiments of the present invention, the multimedia crawler 210 may execute on one or more servers. In certain embodiments, the multimedia crawler 210 is implemented as an additional processing stage on top of an existing image crawler designed for contextual image searching. The multimedia crawler 210 may visit multimedia located on computers or storage devices at a variety of network locations. In one embodiment, the multimedia crawler 210 performs keypoint extraction and descriptor assignment for each multimedia crawled, stores an association between the resulting keypoint descriptors, two-dimensional keypoint coordinates for the multimedia, two-dimensional scales and other parameters, and a corresponding image name and address such as a uniform resource locator (URL) or uniform resource name (URN) in the spatial multimedia indices 112. In an alternative embodiment, the multimedia crawler 210 may receive and store pre-computed keypoint descriptors, coordinates and any other parameters along with, or instead of, the actual multimedia content from which the keypoints are derived. For instance, next-generation multimedia-capture formats may utilize keypoint data as part of the multimedia file or metadata, and may send the keypoints across a network in addition to or in lieu of the actual multimedia content. Multimedia capture devices, such as mobile phones and digital cameras may compute the keypoints and descriptors and store them in a compressed image file at the time of capture. In another embodiment, the multimedia crawler 210 may be able to act as an agent scanning passive remote repositories of images or a service that allows a client device to actively submit images to the multimedia crawler 210 for processing. The multimedia crawler 210 may include additional processing stages in which the spatial image indices 112 are calculated and/or updated as additional multimedia are ingested. In another embodiment, multimedia crawler 210 may dynamically merge, split, or otherwise re-partition groups of multimedia as the spatial multimedia indices 112 grow or changes over time. Additionally, the multimedia crawler 210 may use semantic information associated with individual multimedia or multimedia subregions to construct, enhance, or modify over time spatial multimedia indices 112.

Accordingly, the multimedia engine 111a mines a very large collection of multimedia to generate the spatial multimedia indices 112. The spatial multimedia indices 112 store spatial and semantic relationships. In certain embodiments, the semantic relationships describe the multimedia location and include keywords, such as author, name, location, etc. The spatial relationships may describe the geographic location associated with the multimedia, the estimated three-dimensional coordinates for the multimedia, projection equations for planar and non-planar surfaces that may be utilized to render the multimedia, and the like.

In an embodiment of the present invention, the spatial multimedia indices 112 may include the multimedia properties index that stores the extracted spatial or semantic relationships. In certain embodiments, the multimedia properties index relates the multimedia to keypoints and descriptors. Accordingly, each multimedia stored or having a reference in the multimedia properties index is associated with one or more properties extracted or estimated by the keypoint extractor 220.

In an alternate embodiment, a properties concordance index relates the extracted and estimated keypoints shared among multiple images to each other. In one embodiment the properties concordance index includes undirected graphs with each edge of the graph connecting nodes that represent extracted keypoint(s) in one multimedia with keypoint(s) in another multimedia. In one embodiment, the keypoint(s) in a first multimedia represent extracted two-dimensional properties that are connected to keypoint(s) that represent estimated three-dimensional information associated a second multimedia. This may occur when the multimedia engine 111a determines that the keypoints in the first and second images represent a particular geographical region from different vantage points. In other words, the properties concordance index may link a two-dimensional properties of a first multimedia with estimated three-dimensional information of a second multimedia that may relate to the same feature in three-dimensional space. All connected nodes in a graph are imputed to the multimedia having at least one extracted keypoint as a connected node in the graph. Accordingly, the extracted keypoints stored in the properties concordance index may be visible in more than one multimedia. In certain embodiments, edges of the graph may be labeled with weights that represent a confidence level or probability that the keypoints connected by the edge comprise different views or formulations of the same feature in a three-dimensional space.

Additionally, the properties concordance index may be represented as a dense or sparse matrix, or a variety of other data structures from which concordances may be efficiently extracted, such as a kd-tree having keypoints represented as vectors. Accordingly, the spatial multimedia indices 112 store relationships between the extracted two-dimensional properties and estimated three-dimensional properties. Additionally, the extracted two-dimensional and three-dimensional properties are related to each multimedia to provide efficient access to related multimedia having linked keypoints.

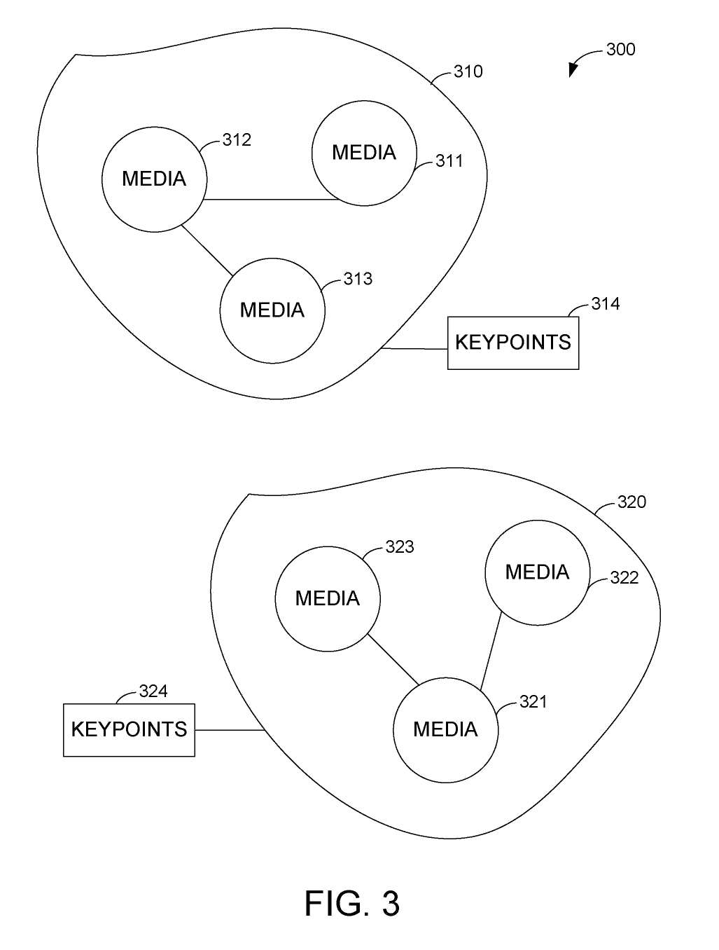

In another embodiment, the spatial multimedia indices 112 provide an island index that clusters multimedia sharing more than one property. As new multimedia is processed by the multimedia engine 111a and each cluster that has a keypoint associated with the new multimedia receives a reference to the multimedia. Once the clusters reach a specified size clusters are split to create similarly sized cluster distributions. Furthermore, clusters may be fused when the number of images in a cluster is below a specified threshold. FIG. 3 is a schematic diagram that illustrates islands 310 and 320 associated with multimedia, according to an embodiment of the present invention.

The island index identified is a graph having connected nodes 311, 312, 313 and 321, 322, 323. In an embodiment, the nodes 311, 312, 313 and 321, 322, 323 may represent references to the multimedia or the actual multimedia content. Edges between nodes 311, 312, 313 and 321, 322, 323 in the graphs are created when two or more multimedia share at least one property. The connected nodes 311, 312, 313 and 321, 322, 323 of the graph create islands 310 and 320 based on the extracted keypoints 314 and 324 from the multimedia. Additionally, because the islands are formed based on keypoints 314 and 324, the islands 310 and 320 may represent a common three-dimensional environment where each multimedia of the corresponding island 310 and 320 represents a cluster that may include keypoints 314 and 324 that are putatively assigned to the multimedia of each island 310 and 320.

The island index assigns an identifier to each island 310 and 320 and allows bidirectional queries that return multimedia associated with each island 310 and 320. In an embodiment the bidirectional queries are based on the island identifier or multimedia associated with island. In another embodiment, the island index may also provide unidirectional or bidirectional queries using bounding boxes, tags, physical addresses, coordinate transformations, or other global geometric or semantic information related to the islands.

In an embodiment, when the number of multimedia indexed by the multimedia engine 111a is very large, it may be desirable to split islands that are greater than a specified splitting threshold. Large islands having graphs for the multimedia may be broken into smaller islands. In some embodiments, a graph cutting or partitioning technique may be utilized to split the graph in half along edges that have very low weights.

Alternatively when an island is sparse related multimedia may be replicated across multiple islands to increase the number of multimedia to a specified number of nodes. Additionally, sparse islands that have multimedia in proximity to a specified region are merged to create a single island for the specified region. In another embodiment, islands with outliers and sizes below a specified threshold are merged with each other until a maximum merge threshold is satisfied.

Accordingly, the spatial multimedia indices 112 may create groups or clusters based on shared properties associated with the multimedia. The islands 310 and 320 includes graphs having nodes 311, 312, 313 or 321, 322, 323 that represent multimedia and edges that connect the related multimedia. The weights assigned to the edges may be based on proximity. Multimedia that is close in geographic proximity or estimated three-dimensional space proximity may be assigned high weights while multimedia that are further apart may be assigned lower weights. Each island 310 and 320 is associated with a set of keypoints 314 and 324, respectively, and stores the relationships between the keypoints and the multimedia. The island 310 or 320 efficiently provides access to related multimedia having similar properties. Also, the multimedia provided by an island may be utilized to quickly render and transition between two-dimensional or three-dimensional multimedia associated with geographical locations associated with the island. Moreover, island operations such as splitting and merging are utilized by the multimedia engine 111a to keep islands 310 or 320. When an island becomes large subdividing and graph cutting at edges having low weights is performed until the island size is below a threshold. When an island is too small, merging is utilized to remove singletons or island with small sizes. In some embodiments, when new multimedia is added, the multimedia is compared against the small islands to determine whether an intelligent merger is possible. The intelligent merger may perform object recognition between the islands and the new multimedia and determine that the new multimedia connects two or more islands having very small sizes or singletons and the multimedia engine 111a merges the two or more islands.

In some embodiments, multimedia associated with, e.g., Paris and Seattle will never be connected because the representative islands have large sets of multimedia for the specified geographic areas. Typically, the islands 310 or 320 provide large sets of images having different areas of coverage. In certain embodiments, the islands 310 or 320 are utilized to create space-scale hierarchies, where multimedia for various geographic regions such as states, continents, or countries, are efficiently indexed based on, among other things, scale. Each space-scale hierarchy may include islands 310 or 320 having moderate sizes to efficiently process requests at varying levels of the space-scale hierarchy.

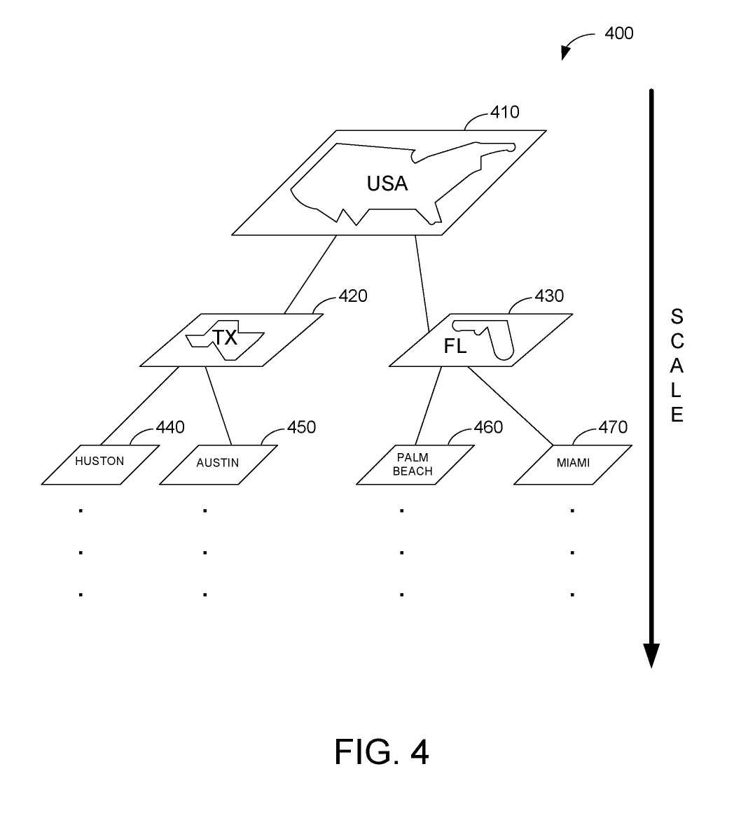

FIG. 4 a schematic diagram that illustrates a space-scale hierarchy 400, according to an embodiment of the present invention.

In some embodiments, scale information is extracted from the multimedia. The scale information may be inferred from the estimated three-dimensional features visible in the multimedia and may be used to cluster or partition the spatial multimedia indices into islands having varying scale. In certain embodiments, the islands of varying scale are connected in a tree to form the space-scale hierarchy 400.

Generally, multi-scale island partitioning may provide islands having multimedia of a similar scale. That is, the islands provide a compact scale distribution and an average scale. Also, islands are associated with approximate three-dimensional information that is estimated from the two-dimensional properties of the multimedia. For instance, three-dimensional information may be estimated from the ground plane for terrestrial multimedia. Accordingly, the islands provide a space-scale hierarchy that efficiently represents large collections of multimedia having varying scales. The hierarchy may include a large scale representation island 410 that includes multimedia from a geographic region, such as the United States of America. Subsequent levels of the hierarchy reduce in scale, such that the multimedia at each island represents a different scale of the region of interest. For example the space-scale hierarchy may include state islands 420, 430 that associate multimedia with a specified state, and city islands 440, 450, 460 or 470 that associate multimedia with a specified city. Accordingly, each level of the space-scale hierarchy stores multimedia at a different scale. In certain embodiments, the space-scale hierarchy moves, e.g., from state to city, from city to street, and from street to storefront. Other space-scale hierarchies may provide multimedia associated with the universe, world, continent, or countries. For instance, satellite multimedia of the United States may form an island of several hundred multimedia files. Aerial multimedia of Seattle may form an island of several hundred images at a finer scale than, and hierarchically under, the United States images. Wide-angle multimedia of Pike Place Market may comprise another island at a finer scale and under the Seattle island. A collection of snapshot multimedia for an individual market stall may comprise yet another island. Each neighboring market stall associated with a collection of multimedia may have its own island. Remote navigation to furnish the user with an immersive experience through the multimedia stored in the space-scale hierarchy 400 is efficient because the number of islands required by the client processor scales as a logarithm of the number of images indexed.

In an embodiment, the three-dimensional information for a given island may include two-dimensional properties. Additionally, islands at different scales may share some common three-dimensional information to enable transitions between multimedia at the different levels of the space-scale hierarchy 400. Moreover, the shared three-dimensional information may automatically update the two-dimensional or three-dimensional properties associated with each island.

Accordingly, the multimedia engine 111a may process very large multimedia corpuses having different areas of coverage and efficiently store the multimedia in space-scale hierarchies 400. The multimedia engine 111a utilizes a divide and conquer technique by scale and space when linking islands having different scales for each region. The space-scale hierarchies 400 provide multimedia at varying levels from state-level to store-front level. The space-scale hierarchy 400 effectively reduces a number of multimedia accessed by a client when generating a specified geographic location, such as state, city, street or store.

In other embodiments, the spatial multimedia indices may include a properties spatial index is configured to store island identifiers and estimated three-dimensional coordinates for three-dimensional information stored in the properties concordance index. The properties spatial index can be queried by specifying a region in three-dimensional space and return a result set having a collection of islands intersecting the given region, a set of three-dimensional properties intersecting with the region and/or a set of image identifiers in which the three-dimensional properties are visible. In certain embodiments, the properties spatial index is also configured to store properties of three-dimensional features, such as three-dimensional scale, orientation, shape, color, lighting or material and three-dimensional coordinates associated with each to the three-dimensional features. The properties spatial index exploits island and feature scales to provide hint data that constrains a query to multimedia and/or islands of the specified query scale. Accordingly, the results are consistent with the scale of the specified query regions.

Accordingly, the properties spatial index provides access to three-dimensional information for each island. The three-dimensional information is estimated from the multimedia. In an embodiment, three-dimensional coordinates are estimated from at least two multimedia representing different viewpoints of a specified region or object. The at least two multimedia are utilized for triangulation and to postulate positions for three-dimensional features and coordinates. When the islands merge or split, or new multimedia is added to an island, the three-dimensional coordinates and features associated with the island(s) are refined and the properties the spatial index is updated.

In another embodiment, the spatial multimedia indices 112 may include a multimedia viewpoint index configured to relate multimedia to estimated properties for a multimedia capture device through which the multimedia was captured. The multimedia viewpoint index may include island information, multimedia-capture position in three-dimensional space, multimedia-capture orientation, focal length, and/or a perspective matrix. The multimedia viewpoint index may duplicate multimedia metadata, such as, for example, time of day, date, and ISO setting, and it may further include metadata-derived and/or computationally estimated parameters such as color balance and barrel distortion. In certain embodiments, the multimedia viewpoint index allows queries based on any estimated or retrieved multimedia-capture device information.

Accordingly, the multimedia viewpoint index provides viewpoint information that describes a virtual camera that may be associated with the multimedia. The virtual camera may estimate focal length and other related information that may effectively describe a viewpoint. Each multimedia or island is associated with viewpoint information which may be utilize to render and transition between multimedia.

In another embodiment, the spatial multimedia indices include, a multimedia projection index that relates multimedia to one or more two-dimensional or three-dimensional surfaces embedded in a three-dimensional space associated with an island. The two-dimensional or three-dimensional surfaces are screens for projecting the multimedia or collection of multimedia associated with an island. In some embodiments, the multimedia projection index may supply variable projection surfaces associated with one or more multimedia files. The variable projection surfaces are a collection of surfaces per multimedia. Each surface is specified for use during multimedia-to-multimedia transitions with certain other multimedia. For example, a pair of overlapping multimedia may share a common surface fitted to their shared properties. During transition between these two multimedia, the shared surface is projected onto by both multimedia with preference to their own surface. Simultaneously, one of the two multimedia fades out and the other multimedia fades in. In an embodiment, another shared surface is used to transition from the faded-in multimedia to the faded-out multimedia. The variable surface includes a number of permutations for surface transitions that allow multimedia that share common surfaces to transition with unnoticed breaks or flickers.

In certain embodiments, the multimedia projection index may also include constraints on viewing angle or position. The constraints signal a limited range of perspectives over which a given image can be viewed without undue distortion. The image projection index enables queries based on regions, islands, or three-dimensional space and provides a result set having relevant multimedia and associated projection surfaces.

Accordingly, the multimedia projection index relates projection surfaces to islands or multimedia. Projection screen or surface information may describe planar and non-planar surfaces in two-dimensional or three-dimensional coordinate systems as equations for simple or complex geometries. Further, the projection surfaces include transition surfaces that are multi-screen surfaces linking multimedia sharing common environments, and constraints that describe a field of view for the multimedia and projection surface. The projection surfaces operate to receive multimedia projected from a specified multimedia-capture orientation or position. In some embodiments, the multimedia-capture position or orientation represents a virtual camera.

In another embodiment, the spatial multimedia indices 112 include a spatial tag index that associates tags, such as words, phrases or other semantic information with islands, multimedia, multimedia metadata, regions of multimedia, geometric regions within islands, three-dimensional features, or sets of three-dimensional features. The spatial multimedia indices enable queries that include semantic information and may access the multimedia metadata or other tag information to respond to the queries and provide an island or multimedia that matches the query.

Accordingly, the spatial tag index provides tags that are related to the islands or multimedia. In certain embodiments the tags include information about the proximity of the multimedia in a three-dimensional space or on a world map.

In operation, providing spatial multimedia indices 112 that spatially cross-index multimedia containing shared properties enables immersive browsing of multimedia gathered from different client devices, but representing a particular geographic location, object, etc. For instance, a user could utilize the spatial multimedia indices 112 to create a three-dimensional walk around a geographic location or object from a collection of two-dimensional multimedia. In other embodiments, a thumbnail of an object may automatically act as a proxy to an immersive walk-around experience automatically created from other multimedia stored on the network, without incurring additional content authoring costs.

As indicated above, spatial queries may access semantic information as well as geographic information for multimedia stored in the spatial multimedia indices 112. FIG. 2B is a block diagram that illustrates a query engine 111b, according to an embodiment of the present invention.

The query engine 111b is configured to interface with the spatial multimedia indices 112 to provide multimedia information or properties associated with multimedia. The query engine 111b may include an update component 230 and a matching component 240. The update component 230 is configured to process queries that include properties extracted by a client device or multimedia received from the client device. When the properties or multimedia are not stored in the spatial multimedia indices 112, the update component 230 updates the spatial multimedia indices 112. In an embodiment the client device may indicate that a query is an update query for adding information to the spatial multimedia indices 112.

The matching component 240 is configured to traverse the spatial multimedia indices 112 to determine whether a match exists for the properties or multimedia specified in the queries. When a match exists, a result set is generated that includes multimedia and/or properties associated with multimedia. When a match does not exits, the query is processed by the update component 230.

Accordingly, the query engine 111b is configured to process queries, to update the spatial multimedia indices 112, and/or to generate result sets associated with the multimedia or properties included in the queries.

The queries may be generated by client devices, such as mobile devices, laptops or other server devices. In some embodiments, the client queries include hint data that is utilized to refine the client queries. The hint data may clarify the scope of a search performed on the spatial multimedia indices and may allow the query engine to efficiently process the client queries by reducing the segment of the spatial images indices that are searched for a match.

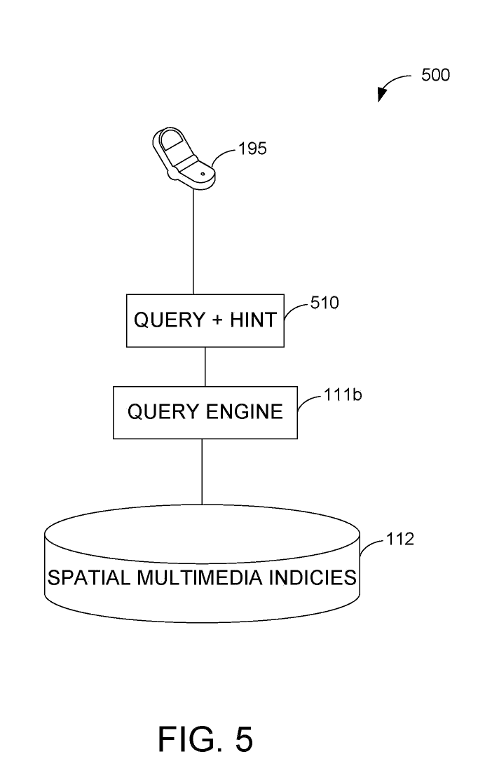

FIG. 5 is a block diagram that illustrates a mobile device 195 generating a query 510, according to an embodiment of the present invention. The mobile device 195 issues a query 510 and hint data is automatically appended to the query 510 generated by the mobile device. The query engine 111b receives the query 510 and determines whether the query 510 is an update request or a search request. When the query is an update request, the spatial multimedia indices 112 are updated. Otherwise, the spatial multimedia indices are traversed to locate matches for query 510 and to generate a result set that contains the matches included in the spatial multimedia indices 112.

In some embodiments, the spatial multimedia indices 112 may be queried by submitting the multimedia or precomputed keypoints and descriptors or properties associated with the multimedia. For instance, a camera-enabled mobile phone 195 may submit a query including a newly-photographed image to the spatial multimedia service, which transforms the newly-photographed image into properties or keypoints and descriptors and transforms the query to include the extracted properties or keypoints and descriptors. The query is then processed utilizing the properties or keypoints and descriptors In response, the spatial multimedia indices 112 may return a result set matching the properties or keypoints and descriptors in the query result. The result set may include three-dimensional information, semantic information, multimedia, and/or two-dimensional properties.

In other embodiments of the present invention, the spatial multimedia service may process the extracted properties or keypoints and descriptors to calculate an approximate position and orientation for the mobile phone camera at the time the newly-photographed image was taken. The mobile phone's mobile network cell identifier, GPS coordinates, identifiers for wireless networks in the vicinity, and/or any other ancillary information that can be used to infer an approximate or precise location and/or orientation for the mobile phone may be used as a spatial “hint” to accelerate the traversal of the spatial multimedia indices 112. Typically, the spatial hint constrains a query to one or more geographical sub-regions in the spatial multimedia indices 112. Spatial hints may be gleaned from a location identified a previous time the spatial multimedia service was used by the client device, or a travel calendar or schedule stored on the client device. In certain embodiments, textual information recognized using recognition techniques, such as optical character recognition, on the image may also be used recognize a street sign as a spatial hint. Moreover, geocoding databases may be exploited to convert geographic text such as place names and street signs into spatial hints having more attributes. For instance, “Springfield Town Center” may constrain a search to any of the towns in the world named “Springfield.” While there are many Springfields, the constraint eliminates most geographic areas from consideration. Alternatively, or additionally, multimedia indexed in the spatial multimedia indices 112 may have tags automatically added containing any text identified in these images.

In some embodiments, the spatial multimedia service may augment services such as street directions and local search to provide multimedia associated with a specified region.

In another embodiment, the mobile phone 195 in addition to using an image as a query, may automatically submit this image to the Crawler, such that as the spatial multimedia service processes user queries, the spatial multimedia indices 112 grows. Moreover, the mobile phone 195 may make a query without submitting the original query multimedia by performing multimedia-based recognition techniques or extracting properties or keypoints and descriptors. The extracted information may be submitted as a query. In some embodiments, estimated three-dimensional information and other parts of the spatial multimedia indices 112 are updated by the queries in the absence of the accompanying image. As an example, if the extracted information includes its average color, then this average color may be utilized to update the average color of multimedia having a similar color.

Accordingly, queries may include actual multimedia content of extracted properties. The queries may update the spatial multimedia indices 112 or request related multimedia or properties associated with the extracted properties or actual image content. The queries may be refined with spatial hints extracted from the multimedia, provided by a global positioning system (GPS) enabled device or a geographical service. The spatial hints may improve the processing of the query when traversing the spatial multimedia indices.

Embodiments of the present invention may additionally provide a computer-implemented method for generating multimedia indices. The spatial multimedia indices 112 may include multimedia from various locations and provides relationships between the multimedia and the extracted properties. In some embodiments the relationships include a space-scale hierarchy that provides islands of multimedia having varying scales at different levels of the hierarchy.

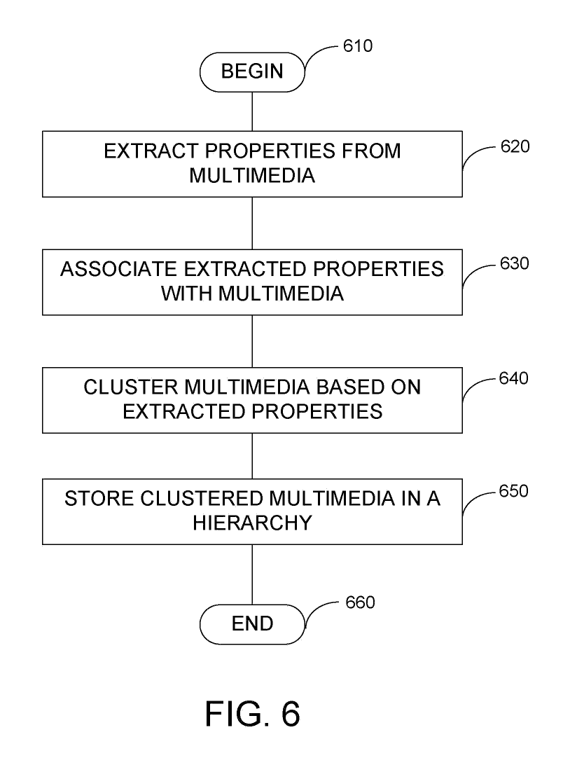

FIG. 6 is a flow diagram that illustrates a method for generating multimedia indices, according to an embodiment of the present invention. The method initiates at 610 when the spatial multimedia service is executed. Multimedia having different viewpoints is provided to the spatial multimedia service and properties are extracted from the multimedia at 620. The extracted properties are associated with the multimedia at 630. In turn, at 640, the multimedia are clustered into one or more islands based on the extracted properties. Optionally, the multimedia may store the clustered information into a hierarchy at step 650. The method terminates at 660.

In summary, in an embodiment of the invention, a spatial multimedia service generates spatial multimedia indices and provides a query engine to interface with the spatial multimedia indices. The spatial multimedia indices stores spatial and semantic information associated with the multimedia and provides a query engine that updates the spatial multimedia indices or generates results based on the information included in the query.

In other embodiments of the invention, a system for generating spatial multimedia indices is provided. The system may include a plurality of multimedia capture devices that generate multimedia having different view points. The multimedia capture devices are communicatively connected to a network and may transmit captured multimedia to a spatial multimedia service executing on a server connected to the network. One or more corpuses of multimedia stored at different locations on the network are traversed by a crawler component of the spatial multimedia service. The crawler component may gather the multimedia generated by the multimedia capture devices and stored at the one or multimedia corpuses. An extraction component of the spatial multimedia service extracts one or more properties from the gathered multimedia and clusters multimedia that share one or more properties.

The foregoing descriptions of the invention are illustrative, and modifications in configuration and implementation will occur to persons skilled in the art. For instance, while the present invention has generally been described with relation to FIGS. 1-6, those descriptions are exemplary. Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims. The scope of the invention is accordingly intended to be limited only by the following claims.

1. A computer-implemented method to generate a spatial multimedia index, the method comprising:
extracting properties from a collection of multimedia having different view points;
associating each multimedia with the extracted properties; and
clustering multimedia based on the extracted properties.

2. The method of claim 1, wherein the collection of multimedia is generated by receiving at least one multimedia of the collection of multimedia from one or more multimedia capture devices.

3. The method of claim 1, wherein the collection of multimedia is generated by crawling a network.

4. The method of claim 3, wherein multimedia in the collection of multimedia are stored at different locations on the network.

5. The method of claim 4, wherein the network is the Internet.

6. The method of claim 1, wherein the multimedia are stored at a central location.

7. The method of claim 1, further comprising storing the clustered multimedia in a hierarchy having a plurality of levels.

8. The method of claim 7, wherein the multimedia are stored at varying levels of the hierarchy based on geographic location.

9. The method of claim 7, wherein the multimedia is stored at varying levels of the hierarchy based on physical scale.

10. The method of claim 9, wherein the physical scale is one of: universe, planet, continent, country, state, city, street, shop, department, aisle, or goods.

11. The method of claim 1, wherein semantic information is associated with at least one of a multimedia cluster and a particular multimedia included in a multimedia cluster.

12-20. (canceled)

21. One or more computer-readable media having stored thereon a data structure, comprising:
one or more fields for spatial multimedia indices that store spatial relationships and semantic relationships between multimedia having different view points; and
one or more spatial relationship fields for indicating whether at least two multimedia share one or more extracted properties and for providing a reference to the multimedia and one or more extracted properties, the extracted properties including two-dimensional information and three-dimensional information estimated from the two-dimensional information, wherein the estimated three-dimensional information is utilized to render and transition between the multimedia.

22. The media of claim 21, wherein the one or more fields for spatial multimedia includes an island index for clustering multimedia sharing extracted or estimated properties.

23. The media of claim 21, wherein the one or more fields for spatial multimedia includes a viewpoint index that stores virtual camera information that is utilized to render the multimedia.

24. The media of claim 21, wherein the one or more fields for spatial multimedia includes a projection index that describes planar or non-planar screens associated with each multimedia in the cluster index.

25. The media of claim 21, wherein the one or more fields includes a projection index that describes variable screens utilized to transition between multimedia having shared properties.

26. The media of claim 21, wherein the properties include one or more of geographic location and physical scale.

27. A method to query spatial multimedia indices, the method comprising:
receiving a request having multimedia or extracted properties from the multimedia;
generating one or more hints from the multimedia or extracted properties;
refining the request with the hints; and
submitting the request and hints to a query engine that interfaces with the spatial multimedia indices.

28. The method of claim 27, wherein the hints are spatial hints that specify at least one of a physical scale associated with the multimedia or extracted properties or a geographic region associated with the multimedia or extracted properties.

29. The method of claim 18, wherein the hints include travel information received from an electronic calendar associated with the multimedia capture device that captured the multimedia.
